(19) United States
(12) Patent Application Publication
(10) Pub. No.: US 2025/0278988 A1
(43) Pub. Date: Sep. 4, 2025

(54) SYSTEM AND METHOD FOR SHRINKAGE DETECTION AND PREVENTION IN SELF-CHECKOUT SYSTEMS

(71) Applicant: CARNEGIE MELLON UNIVERSITY, Pittsburgh, PA (US)

(72) Inventors: MARIOS SAVVIDES, Pittsburgh, PA (US); MAGESH KANNAN, Pittsburgh, PA (US)

(73) Assignee: CARNEGIE MELLON UNIVERSITY, Pittsburgh, PA (US)

(21) Appl. No.: 19/210,451

(22) Filed: May 16, 2025

Related U.S. Application Data
(63) Continuation-in-part of application No. PCT/US25/16215, filed on Feb. 17, 2025.
(63) Continuation-in-part of application No. PCT/US25/20164, filed on Mar. 17, 2025.
(60) Provisional application No. 63/649,109, filed on May 17, 2024.
(60) Provisional application No. 63/554,687, filed on Feb. 16, 2024.
(60) Provisional application No. 63/565,729, filed on Mar. 15, 2024.

(51) Int. Cl. G07G 3/00; G06T 7/73; G06V 10/25; G06V 10/26; G06V 10/44; G06V 10/74; G06V 10/94; G06V 20/52; G07G 1/00

(52) U.S. Cl. CPC G07G 3/003; G06T 7/73; G06V 10/25; G06V 10/26; G06V 10/44; G06V 10/761; G06V 10/94; G06V 20/52; G07G 1/0045

(57) ABSTRACT

Disclosed herein is a novel system and method to reduce theft and errors in the self-checkout process. The system and methods disclosed herein reconcile purchased products with receipts for those products by corresponding, analyzing, and/or comparing information on self-checkout transaction receipts with captured images of purchase products from camera feeds to ensure that all products purchased via a self-checkout system have been properly scanned and accounted for.

### RELATED APPLICATIONS

This application claims the benefit of U.S. Provisional Patent Application No. 63/649,109, filed May 17, 2024.

This application is also a continuation-in-part application filed under 35 U.S.C. § 111 (a) of PCT Application No. PCT/US25/16215, filed Feb. 16, 2025, which claims the benefit of U.S. Provisional Patent Application No. 63/554,687, filed Feb. 16, 2024.

This application is also a continuation-in-part application filed under 35 U.S.C. § 111 (a) of PCT Application No. PCT/US25/20164, filed Mar. 17, 2025, which claims the benefit of U.S. Provisional Patent Application No. 63/565,729, filed Mar. 15, 2024.

The contents of these applications are hereby incorporated herein in their entireties.

### BACKGROUND

Retailers are increasingly adopting self-checkout stations to cut staff costs and improve operations. Self-checkout stations are machines that allow customers to complete their own purchases with a retailer without using a staffed checkout. In the typical operation of a self-checkout station, customers scan item barcodes appearing on the products using a laser scanner, or are able to lookup product SKUs at the self-checkout station (some products, for example produce at a grocery store, may also be weighed at the self-checkout station, and the self-checkout station may calculate a cost based on the weight of the product). As the barcode for each scanned product is scanned, a corresponding product UPC is added to the receipt. These receipt barcodes are used to compute the total bill of the transaction.

The self-checkout station provides a means for accepting payment for the products from the customer and providing a receipt summarizing the customer's purchases. Customers also typically bag their own products. As such, the customer exits the store without the need for one-to-one staff assistance.

For shoppers, self-checkout may provide a more convenient and speedier experience. For retailers, cost savings may be realized as the need for multiple staff members may be reduced to a single employee who oversees multiple self-checkout stations.

However, the steady adoption of self-checkouts by retail businesses has been accompanied by certain challenges. For example, due to human error or malicious intent, incorrect barcodes may be scanned, or products may be left unscanned, but still placed in the bag (i.e., theft). This can result in incorrect information on the generated receipt and, consequently, a significant loss to the retailers. Thus, there exists a need for a solution to improve self-checkout accuracy and verification of receipts and purchases.

### SUMMARY OF THE INVENTION

To address the issues identified above, disclosed herein is a novel system and method relating to product verification. The disclosed invention includes one or more processes and methods to validate information on checkout transaction receipts using captured images from one or more cameras at a self-checkout station. In some embodiments, checkout validation may be performed during the checkout process (single verification mode). In some embodiments, checkout validation may be performed after the checkout process (batch verification mode). In some embodiments, checkout validation may be performed as a store-wide audit (for example, at regular intervals, at discretion, and/or at random).

In a first embodiment of the invention multiple, different views of products in a store catalog may be captured and enrolled into a product gallery. The product gallery also contains a standard UPC image of the product. The different views may include views of different faces of the product and views of the product faces in different orientations (e.g., rotated, askew, upside down, etc.).

In a second embodiment of the invention, a “skip scan” is detected, where no bar code is able to be scanned from the product, either due to poor scanning methods or by an intentional action to conceal or otherwise prevent the barcode from being scanned as the product is moved across the scanner. In this case an alert is raised.

In a third embodiment of the invention, a reverse lookup process is disclosed for verifying a match between a scanned UPC and one or more images of the product captured as the product is scanned during the self-checkout process.

In a fourth embodiment of the invention, a predictive process is disclosed, wherein the UPC of the product is predicted from the cropped scans of the product, and it is determined if the predicted UPC matches the scanned UPC.

### BRIEF DESCRIPTION OF THE DRAWINGS

By way of example, specific exemplary embodiments of the disclosed system and method will now be described, with reference to the accompanying drawings, in which:

FIG. 1 is a flowchart showing the multi-view enrollment process.

FIG. 2 shows the various machine learning models used to process the images.

FIG. 3 is a flowchart showing the skip scan detection process

FIG. 4 is a flowchart showing a reverse lookup process for a single scanned product.

FIG. 5 is a flowchart showing a predictive lookup process for a single scanned product.

FIG. 6 is a flowchart showing the reverse lookup matching process.

FIG. 7 is a flowchart showing the predictive lookup matching process.

FIG. 8 is a flowchart showing a first alternate predictive lookup matching process.

FIG. 9 is a flowchart showing a second alternate predictive lookup matching process.

### Definitions

As used herein, the terms “barcode” and “UPC” are used interchangeably, however, as would be realized, a UPC is typically used to refer to a number that is encoded in a barcode that appears on the product. Further, although the invention is presented in terms of using the UPC to identify each object, the use of the term “UPC” is meant to include any number or other indicia capable of uniquely identifying a product.

As used herein, the term “isolated product image” refers to an image extracted from a larger image which shows only the product (i.e., “segmented”), shows the product with a solid or blurred background (“i.e., cropped”) or shows the product with the background from the larger image (i.e., product is isolated within a “bounding box”). A trained machine learning model may produce any of these versions of an isolated product image. As used herein, the terms “isolated product image” and “crop”, “cropped products” or “cropped product images” or variations thereof are used interchangeably and are meant to mean segmented product images, cropped product images or product images captured in a bounding box such as to isolate a single product within an image captured during a scan of the product.

### DETAILED DESCRIPTION

Some embodiments may include one or more processes and/or methods to validate the information on a checkout transaction receipt and captured images from a visual camera feed on a checkout counter. In some embodiments, robust verification steps may ensure that products scanned by a user through the self-checkout process correspond to the items added to the receipt. In some embodiments, fraudulent transactions, including, but not limited to, unscanned items and incorrectly scanned items, may be flagged and/or reported to authorities, which may reduce theft and revenue loss. In some embodiments, during the product checkout process, as the user scans each item, the corresponding Unique Product Code (UPC) are added to the receipt. In some embodiments, at the end of the transaction, these UPCs may be used to calculate the overall bill for the transaction.

In some embodiments, if an item is being scanned by computer vision, barcode, and/or some other manner, it may also be validated by the methods described herein to check if the product resembles the returned scanned ID. In some embodiments, if the product does not pass the validation check, it may be flagged. In some embodiments, this may be done in real-time or after-the-fact.

The store verification gallery 112 is a database preferably containing feature vectors extracted from images of each product captured from multiple viewpoints, orientation information for each feature vector and, optionally, the actual images from which the feature vectors were extracted, all associated with the unique identifier of the product depicted in the images (e.g., a UPC). Store verification gallery 112 may be automatically built. Each time a particular product is scanned, one or more feature vectors can be extracted from one or more captured images of the product. The feature vectors may be stored in the product database and associated with the UPC of the item. Each feature vector may be compared with feature vectors for that item already stored in the product database and, if the feature vectors are within a certain threshold distance of a feature vector already present in the product database for that item (indicating that a similar viewpoint of the item is already in the product database), the feature vector may not be added. However, if the feature vectors captured from the one or more images are sufficiently different from any other feature vector already stored in the product database for that item (indicating a new viewpoint of the item) the new feature vector may be stored in the product database and associated with the UPC for that item. Images for each product may be captured from all checkouts within the store, including both self-checkouts and employee-assisted checkouts. Additionally, images of the same item captured at different stores may be added to the product database such as to have as many possible viewpoints of the item as possible stored in the product database.

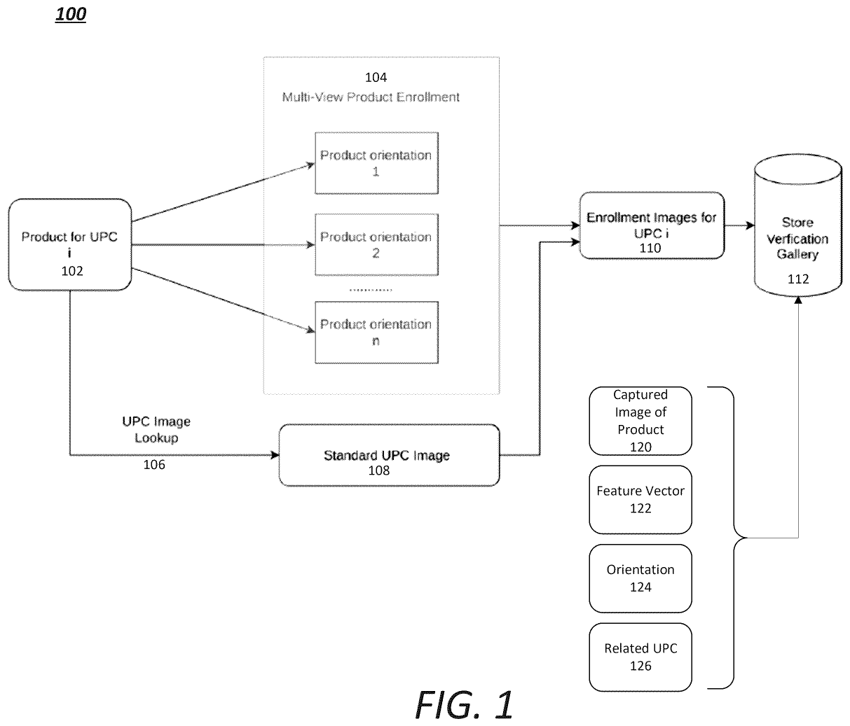

In a first aspect of the invention, products are enrolled in the store verification gallery 112 by the process 100 shown in FIG. 1, which shows the enrollment of product 102. In one embodiment, a standard UPC image 108 of the product 102 is retrieved. The standard image 108 may be retrieved using a lookup process 106, wherein the image is provided, for example, by the manufacturer of product. Alternatively, standard UPC image 108 is captured as a standard view of the product using any camera. The standard UPC image 108 is typically a frontal image showing an unobstructed and unobscured view of the primary face of product 102.

In addition to standard UPC image 108, multiple additional images 104 of products in various orientations may be added to gallery 112. The multiple additional images 104 may be captured, in one embodiment, by one or more cameras located adjacent to or within the checkout station as product 102 is being scanned by customers in the store or in multiple other stores. In other embodiments, multiple images 104 may be captured using any camera. Multiple images 104 may include images of product 102 captured at different orientations, angles and or viewpoints and/or showing different faces of product 102 and with varying degrees of obscuration.

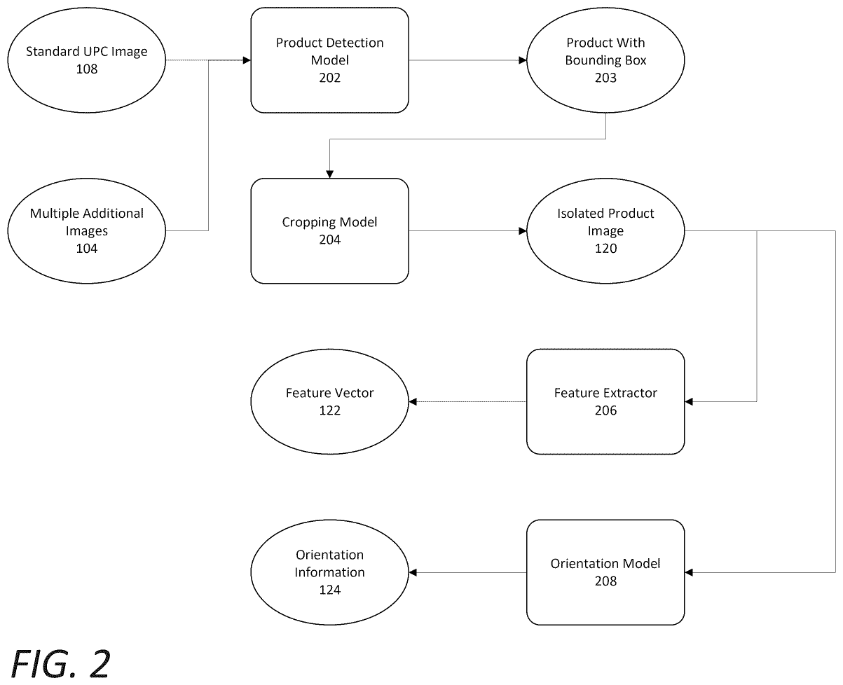

The captured images of products may be processed by a machine learning product detection model 202, shown in FIG. 2, trained to place a bounding box around product 102. The images within bounding boxes 203 may then be cropped by a machine learning cropping model 204 trained to extract the bounding boxes from a captured image, modify the background of the bounding box or segment the image such as to remove all background, leaving only an isolated product image 120 of product 102. In other embodiments, any means of detecting and isolating the products within the captured images may be used.

Isolated product images 120 of product 102 (including both the multiple views 104 and the standard UPC image 108) may be further processed by a trained feature extractor 206, which extracts a feature vector 122 from the isolated product image. In some embodiments, both the feature vectors 122 and the isolated product images 120 are enrolled in gallery 112 at 110, while in other embodiments, only the feature vectors 120 are enrolled in gallery 112.

In addition, an indication of the orientation 124 of the product depicted in isolated product image 120 may also be stored in gallery 112. The orientation may be determined, in some embodiments, by a machine learning orientation model 208 trained to determine the orientation, or by any other means.

Lastly, each isolated product image and/or feature vector of product 102 is associated, in gallery 112, with the UPC code of the product 126, or is associated with other identifying information (e.g., a SKU number) uniquely identifying product 102.

The store verification gallery 112 is a database preferably containing feature vectors extracted from images of each product captured from multiple viewpoints, orientation information for each feature vector and, optionally, the actual images from which the feature vectors were extracted, all associated with the unique identifier of the product depicted in the images (e.g., a UPC). Store verification gallery 112 may be automatically built. Each time a particular product is scanned, one or more feature vectors can be extracted from one or more captured images of the product. The feature vectors may be stored in the product database and associated with the UPC of the item. Each feature vector may be compared with feature vectors for that item already stored in the product database and, if the feature vectors are within a certain threshold distance of a feature vector already present in the product database for that item (indicating that a similar viewpoint of the item is already in the product database), the feature vector may not be added. However, if the feature vectors captured from the one or more images are sufficiently different from any other feature vector already stored in the product database for that item (indicating a new viewpoint of the item) the new feature vector may be stored in the product database and associated with the UPC for that item. Images for each product may be captured from all checkouts within the store, including both self-checkouts and employee-assisted checkouts. Additionally, images of the same item captured at different stores may be added to the product database such as to have as many possible viewpoints of the item as possible stored in the product database.

In a second aspect of the invention, products may be verified as a user scans the product at a self-checkout station (single verification mode). The self-checkout station typically consists of one or more lasers oriented to capture and read a bar code present on the product. The barcode typically encodes the UPC or SKU of the product, or other information that can uniquely identify the product. To verify the products as they are scanned, one or more cameras may be located at different positions with respect to the scanner, or within the body of the scanner, to capture one or more images of the product as the user scans the barcode.

Prior to verifying a product, it is first necessary to obtain both a UPC associated with the product as well as one or more images of the product. In some instances, either maliciously or accidentally, a product may be moved over the scanner without the scanner being able to read the barcode on the product. This may be because the customer moves the product over the scanner too fast, holds the product in an orientation wherein the scanner cannot see the barcode, or purposefully covers the barcode as the product is moved over the scanner. This situation is called skip scanning and is defined as moving the product over the scanner and the scanner failing to read the barcode.

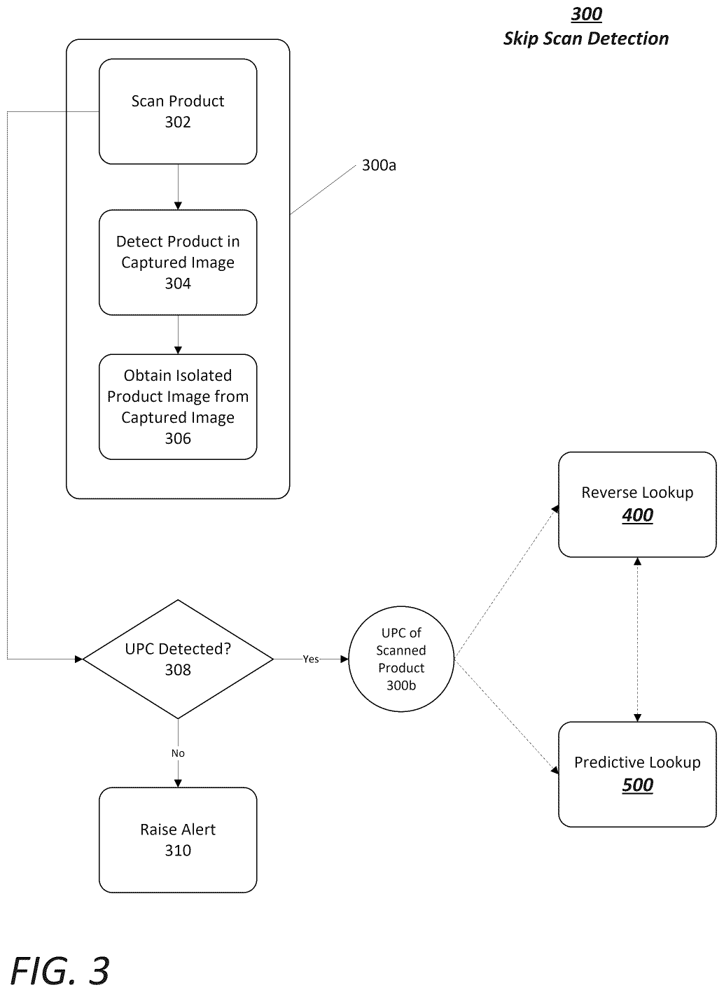

A process 300 for detecting skip scanning is shown in FIG. 3. Process 300 starts when the product is scanned at 302. At 304, products are detected in one or more images captured as the product is being scanned, or immediately before or after. At 306, the captured images are cropped to isolate the product, producing a cropped image of the product. As would be realized, steps 304 and 306 are part of the standard scanning process of the self-checkout system.

As the product is being scanned at 302 one or more images are captured containing the scanned product. It should be realized that as the product is being scanned, the user may hold the product at any convenient orientation with respect to the scanner and with respect to the one or more cameras and that portions of the product may be obscured by the hand of the user, as the user is holding the product to move it over the scanner. In other embodiments, the one or more cameras may be oriented to capture the image(s) immediately before scanning or after the user puts the product down after scanning. This would alleviate difficulties arising from portions of the product being obscured by the user's hand, but may not work in some situations, for example, wherein the user places the product directly into a bag after scanning.

Once the one or more images are captured, they are processed in a manner similar to the process used for enrolling products in gallery 112, shown in FIG. 2, to obtain the isolated (i.e., cropped) product image. In one embodiment, the product may be detected in the image by product detection model 112, which may place the product into a bounding box. In other embodiments, any method of detecting the product in the image may be used. The image may then be cropped to isolate the bounding box. The bounding box may then be processed to replace the background with a solid color, or other effect, or the product may be isolated by a segmentation process, which removes the background, leaving only the isolated product image. The cropping, background processing and/or segmentation may be performed by cropping model 204 or by any other means.

Once the image of the product is isolated to produce the cropped image at 306, feature extractor 206 extracts a feature vector from the isolated product image.

At 308, it is determined if a UPC was successfully obtained as the result of the customer moving the product over the scanner and the scanner successfully reading the barcode on the product. At 310, if no UPC is detected, an alert is raised. The alert may be, for example, in the form of an error message displayed to the customer, an audible alert indicating to store personnel that assistance may be required, or any other form of alert. If, at 308, a UPC 300b was successfully read, no alert is raised. The UPC 300b is used in subsequent steps of the process to verify a match between the UPC and the scanned product.

The cropped image(s) and the UPC obtained in process 300, are used by processes 400 and/or 500 to verify a match between the UPC and the cropped images of the product. This prevents, for example, situations in which the customer acts maliciously to deceive the check-out system by, for example, switching the barcode on the product with one from a less costly product or holding a barcode from a less costly product over the real barcode of the product as the product is scanned.

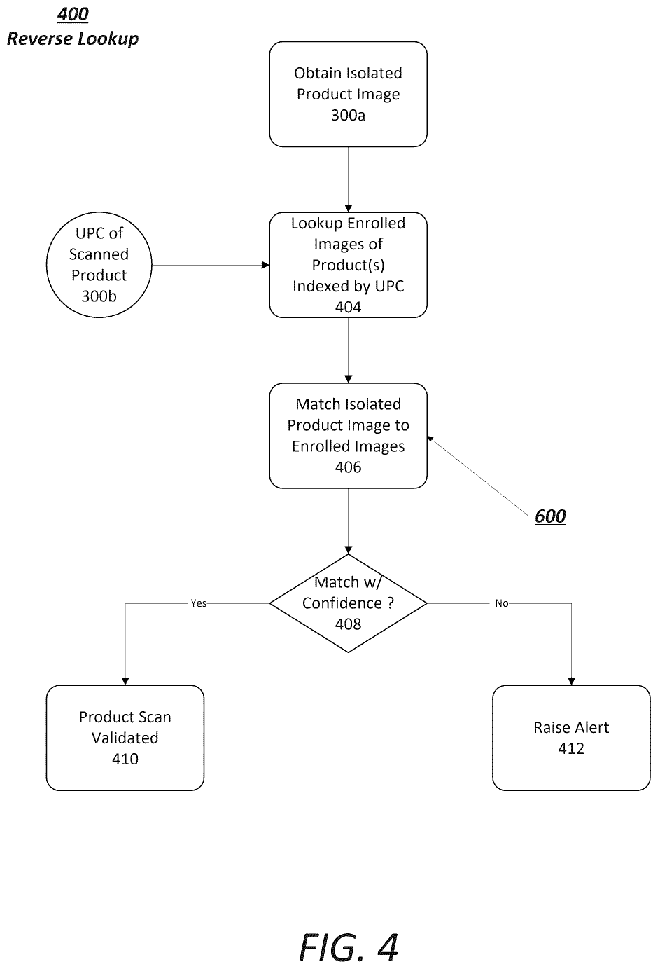

The Reverse Lookup process 400 for verifying the product as the products are being scanned is shown in FIG. 4. The process begins when the isolated product image is obtained by process 300a, discussed previously with respect to the skip scan detection process 300. The isolated product image 300a obtained during the scanning process 300 is used in a matching process at 406 to match the product image against one or more enrolled images of the product. The enrolled images are retrieved at 404 by indexing the gallery 112 using the UPC 300b obtained during the scanning process, such that only enrolled images of the product corresponding to the scanned UPC are retrieved from gallery 112. The details of the reverse lookup matching process 600 will be discussed later herein, but, at 408, if there is a confident match with at least one of the enrolled images corresponding to the scanned UPC, the product scan is validated at 410. If no confident match occurs, then an alert is raised at 412.

The confidence level required to determine if there is a match between the cropped image and an enrolled image may be a user-settable parameter set in accordance with business logic and goals.

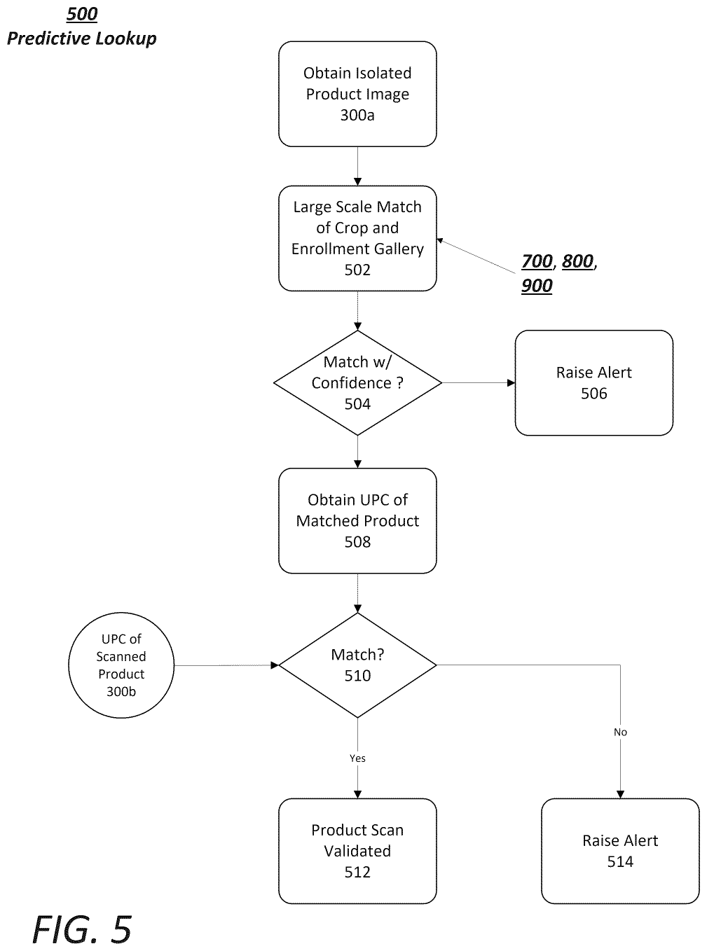

The Predictive Lookup process 500 for verifying the product as the products are being scanned is shown in FIG. 5. As with the reverse lookup process, the predictive lookup process begins when the isolated product image 300a of the product is obtained in process 300. The isolated product image is used in a matching process at 502 to match the product image against one or more enrolled images of the product. In this case, the isolated product image is used in a large-scale matching process 502 in which all enrolled images are considered possible matches. The details of the various embodiments of predictive lookup matching processes 700, 800, 900 are discussed in detail later herein. If there is a confident match at 504, the UPC of the matched product is obtained at 508. At 510, the UPC of the matched product is compared to the UPC from the scanned product. If there is a match at 512, the product is verified as being scanned correctly. If the UPCs do not match, an alert is raised at 514. Note that, if no enrolled image matches with the cropped image with a confidence above the predetermined threshold, an alert may also be raised at 506.

As with the reverse lookup process 400, the confidence level required to determine if there is a match for predictive lookup process 500 at 504 between the cropped image and an enrolled image may be a user-settable parameter set in accordance with business practice, logic and goals.

In various embodiments of the invention, the skip scan detection process 300 may be used with either the reverse lookup process 400 or the predictive lookup process 500. In one embodiment, both reverse lookup 400 and predictive lookup 500 may be used together after the skip scanning process 300 is complete.

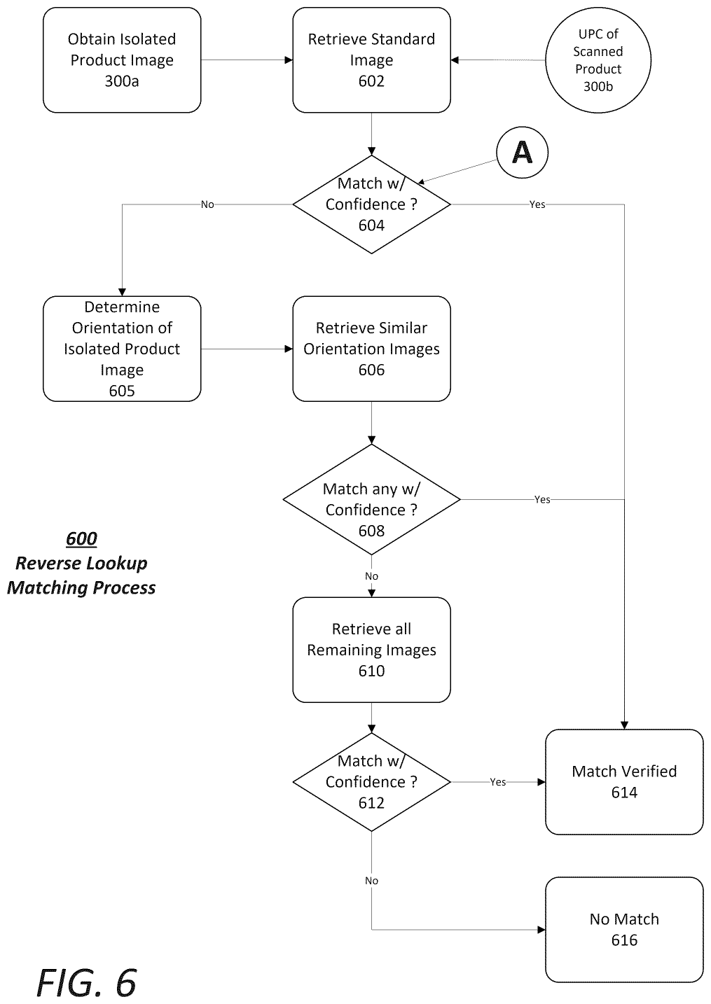

The reverse lookup matching process 600 is shown in FIG. 6. At 602, enrolled standard image 108 corresponding to the scanned UPC 300b is retrieved. A “standard image” or “standard UPC image” is typically one or more images obtained from a manufacturer of a product and may show views of one or more sides of the product (not that standard images need not be supplied by the manufacture but may be created locally by the merchant). Standard images are meant to show the various sides of the product without artifact or background to make matching easier.

If the isolated product image cropped from the captured image matches the standard image 108 with a confidence above a pre-determined threshold at 604, then the match is verified at 614. If no match can be verified using the enrolled standard UPC image 108, then, at 605, the orientation of the product in the isolated product image is determined. The orientation may be determined using orientation model 208 or by any other means. All enrolled images associated with the scanned UPC of the product and indicating the same or a similar orientation as the isolated product image are retrieved at 606. If at least one of the enrolled images matches the isolated product image with a confidence exceeding the threshold at 608, then the match is verified at 614.

If there is still no verified match, then all remaining enrolled images associated with the scanned UPC are retrieved at 610. If the isolated product image matches the any of the retrieved enrolled images with a confidence exceeding the threshold at 612, then the match is verified at 614. Note that different confidence levels can be use at steps 604, 608 and 612. If no match can be verified at any of the 3 stages of the matching process 600, then no match is indicated at step 616.

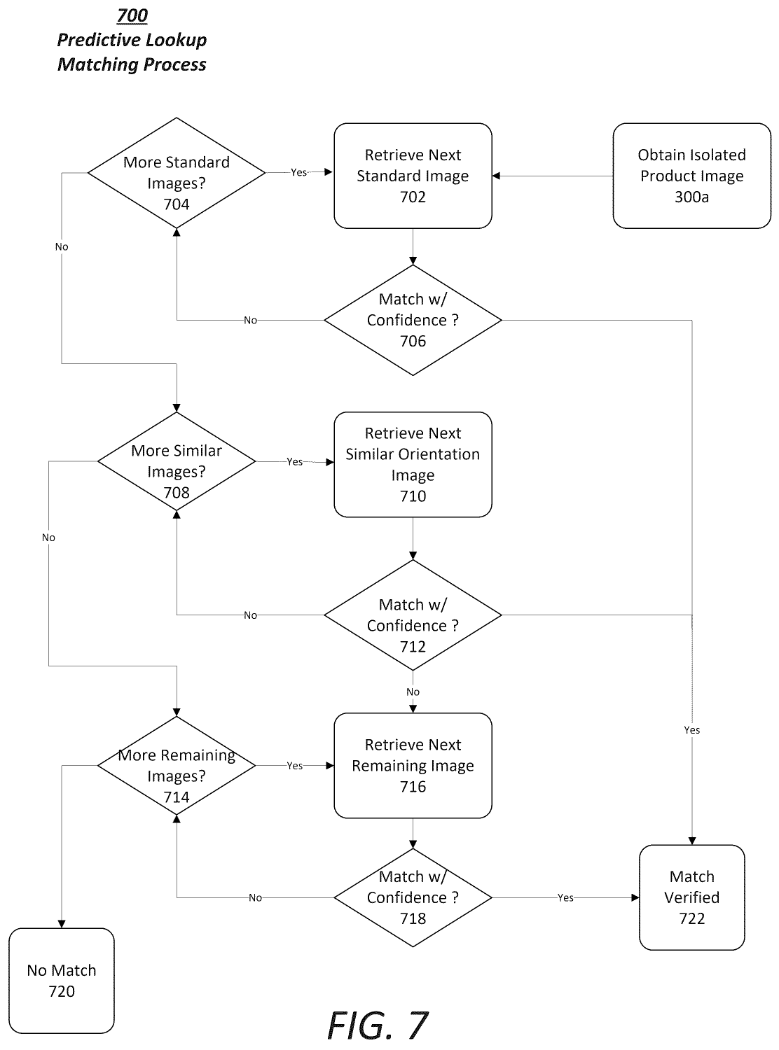

One embodiment of the predictive lookup matching process 700 is shown in FIG. 7. It is first necessary to find a matching image in gallery 112 such that an identifying indica associated with the matching image can be used to match with the barcode data. The matching image is discovered by parsing through images in gallery 112 until a match within the predefined confidence threshold is discovered. One or more isolated product images 300a are obtained. The isolated product image may be a single image or may be two or more images that can be matched independently of each other until a match is found.

At 702, an enrolled standard image 108 is retrieved and compared to isolated product image 300a. If there is a match at 706 within the predetermined confidence threshold, the match is verified at 722 and the process ends. If there is no match at 706, and if there are more standard images at 704, the next standard image 108 is retrieved at 702 and the process repeats until all standard images have been exhausted. If there are no more standard images at 704, the process moves to the next stage.

At 710, an enrolled image having a similar orientation as the isolated product image is retrieved and compared to isolated product image 300a. If there is a match at 712 within the predetermined confidence threshold, the match is verified at 722 and the process ends. If there is no match at 712, and if there are more similarly oriented images at 708, the next similarly oriented image is retrieved at 710 and the process repeats until all similarly oriented images have been exhausted. If there are no more similarly oriented images at 708, the process moves to the next stage.

At 716, any remaining enrolled image is retrieved and compared to isolated product image 300a. If there is a match at 718 within the predetermined confidence threshold, the match is verified at 722 and the process ends. If there is no match at 718, and if there are more remaining images at 714, the next remaining image is retrieved at 716 and the process repeats until all remaining images have been exhausted. If there are no more remaining images at 714, the process ends, and no match is verified. Different confidence levels can be used at steps 706, 712, and 718.

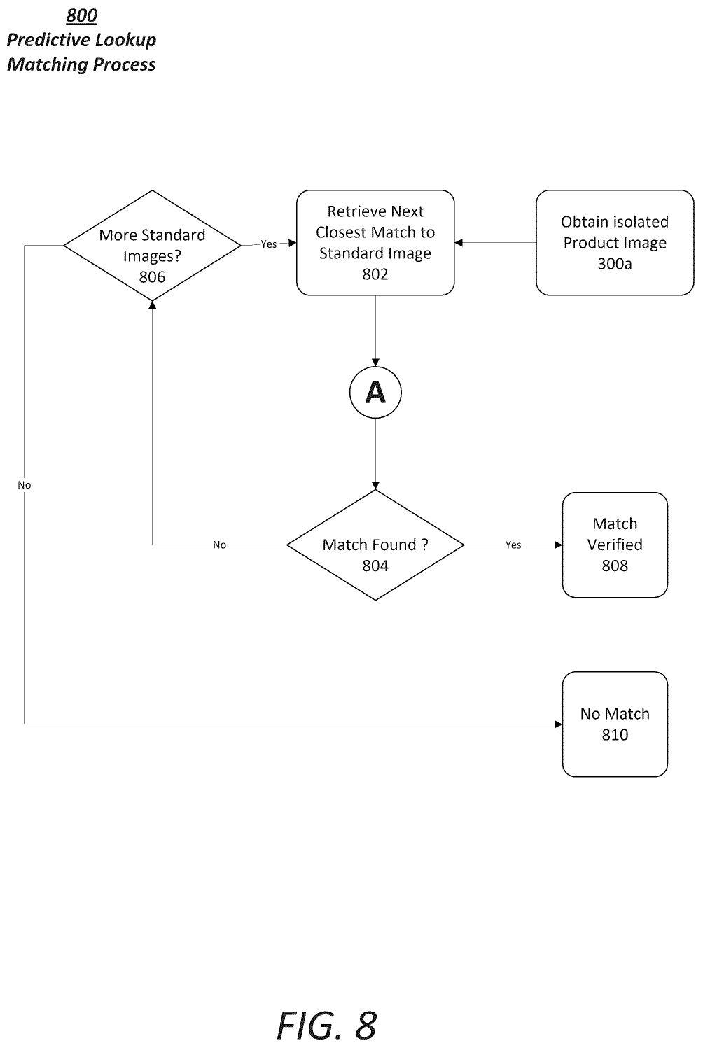

An alternate embodiment of the predictive lookup matching process 800 is shown in FIG. 8. In this embodiment, the gallery 112 is searched at 802 for the closest match enrolled standard image to the isolated product image 300a. The closest match standard enrolled image then uses the three-stage matching process shown in FIG. 6. If no match results at 804, and if there are more enrolled standard images at 806, the process is repeated for the next closest match enrolled standard image. If a match is found at 804, the match is verified. If no match is found after all enrolled remaining images have been iterated through, no match results at 810.

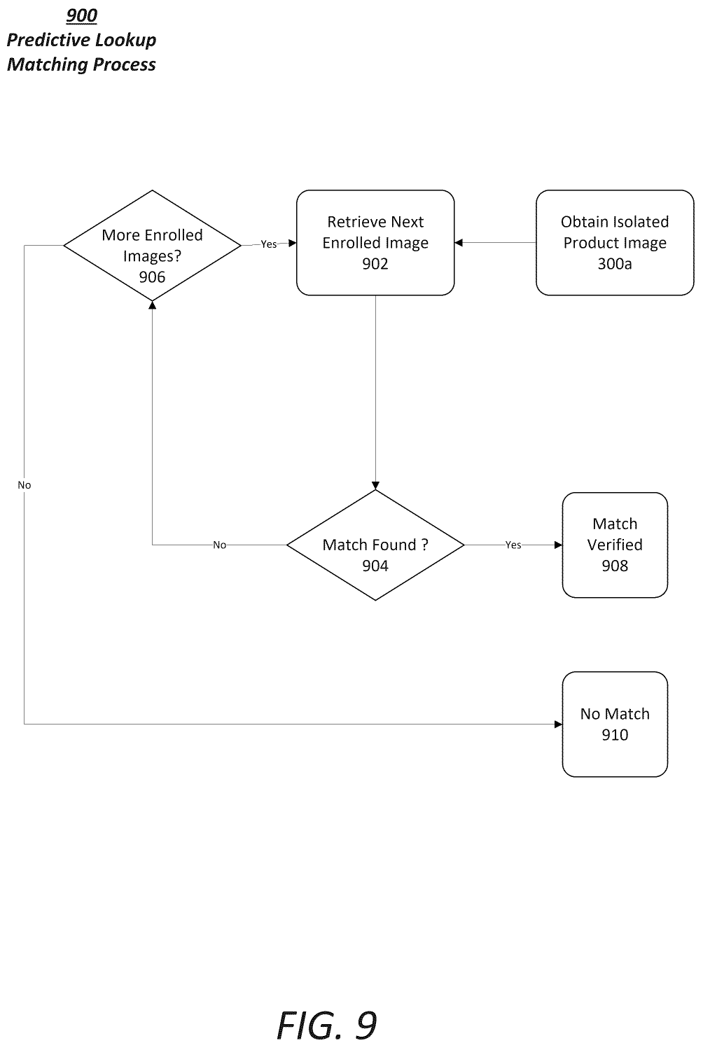

Yet another alternate embodiment of the predictive lookup matching process 900 is shown in FIG. 9. The process iteratively retrieves a next enrolled image from gallery at 902, regardless of whether the image is a standard image, a similarly oriented image or a remaining image. If a match is found between the isolate product image and the enrolled image at 904, a match is verified at 908. Otherwise, if there are more enrolled images at 906, a next enrolled image is retrieved. If there are no remaining enrolled images at 906, then no match is determined at 910.

As would be realized by one of skill in the art, references herein to “retrieving images” from gallery 112 may be interpreted to mean retrieving feature vectors extracted from the images and stored in gallery 112. Likewise, the process of “matching images” may be interpreted to mean that feature vectors extracted from each isolated product image are compared to the feature vectors associated with the enrolled images and the match is assigned a probability based on the similarity of the feature vectors. A match is indicated when the confidence level exceeds a pre-determined threshold. The similarity of feature vectors may be determined by any known means, for example, by cosine distance. The confidence level may be assigned by any known means, based on the similarity between the feature vectors, including by a trained machine learning model.

Any other known means for comparing images to determine a match may be used.

The disclosed invention may include one or more algorithms which flag fraudulent transactions to authorities when an alert is raise at step 310 of process 300 shown in FIG. 3, at step 412 of process 400 shown in FIG. 4, or at step 514 or process 500 shown in FIG. 5, which may help prevent shrinkage. In some embodiments, a general principle of verification logic against false alarms may be used, where the customer receives the benefit of the doubt when the lookup result is within a certain confidence score range.

In various embodiments of the invention, the system upon which the processes and methods are implemented may consist of software implementing the processes and executing on a general-purpose computing device. The software may include a trained product detector capable of detecting individual products in an image of multiple products. The software may further include a trained cropping model. The software may further include a trained feature extractor for extracting feature vectors from images of individual products. The software may further include an orientation model capable of determining the orientation of a product in an image. The software may further include the store verification gallery containing multiple feature vectors extracted from multiple images of individual products. Each feature vector in the product database may be associated with a UPC of the product depicted in the image from which the feature vector was extracted. The system may further comprise one or more cameras coupled to the computing device and associated with various self-checkout stations and one or more cameras coupled to the computing device and associated with a verification station (i.e., for capturing images in batch verification mode). The system may further include the laser scanners used by customers during the self-checkout process to scan barcodes present on the products. The system may further include an application executing on user smart devices to assist in the scanning of products and/or in the verification of the order, as described herein. All components of the system may communicate via wireless connections, for example, Wi-Fi.

The present invention illustrates various techniques and configurations that enable verification of self-checkout orders. As would be realized, many configurations of the system and/or the software are possible and are intended to be within the scope of the invention.

1. A reverse lookup method of verifying scanning of a product at a self-checkout station comprising:
capturing one or more images of the product;
determining that a barcode associated with the product has been scanned coincident with the capturing of the one or more images;
raising an alarm when no barcode has been scanned;
when the barcoded has been scanned:
reading data from the barcode;
extracting one or more isolated images of the product from the one or more captured images;
matching the one or more isolated images to an enrolled image in a gallery of enrolled images;
marking the product as verified when at least one of the isolated images matches at least an enrolled images within a predetermined confidence level; and
raising an alarm when none of the isolated images matches any of the enrolled images within the predetermined confidence level.

2. The method of claim 1 wherein matching an isolated image to an enrolled image comprises:
extracting a product feature vector from the isolated image;
retrieving, from the gallery, an enrolled feature vector extracted from a standard image of the product and associated with an identifying indicia matching the barcode data;
verifying the scan if a similarity between the product feature vector and the enrolled feature vector from the standard image match within a pre-determined degree of confidence;
if the scan is not verified, then:
determining an orientation of the product in the isolated image;
retrieving, from the database, one or more enrolled feature vectors extracted from images of the product in the gallery having a similar orientation to the orientation of the product in the isolated image and associated with the identifying indicia;
verifying the scan if a similarity between the product feature vector and the one or more enrolled feature vectors from images having a similar orientation as the product match with a pre-determined degree of confidence;
if the scan is not verified, then:
retrieving, from the database, all remaining enrolled feature vectors associated with the identifying indicia;
verifying the scan if a similarity between the product feature vector and the remaining enrolled feature vectors match with a pre-determined degree of confidence; and
if the scan is not verified, then:
declaring a mismatch between the product identifier and the scanned product.

3. The method of claim 1 wherein obtaining isolated images of the product comprises:
detecting the product in the captured images; and
cropping the detected product to obtain the isolated image.

4. The method of claim 3 wherein detecting the product comprises:
inputting the image to a machine learning model trained to detect products in an image and place a bounding box around the product.

5. The method of claim 3 wherein cropping the detected product comprises:
inputting the image to a machine learning model trained to crop products in an image.

6. The method of claim 5 wherein the cropping comprises one of:
extracting the bounding box from the image;
extracting the bounding box from the image and modifying the background within the bounding box; or
segmenting the bounding box to remove the background.

7. A system comprising:
a processor;
one or more cameras coupled to the processor;
a scanning device coupled to the processor;
software that, when executed by the processor, implements the functions of claim 1.

8. A predictive lookup method of verifying scanning of a product at a self-checkout station comprising:
capturing one or more images of the product;
determining that a barcode associated with the product has been scanned coincident with the capturing of the one or more images or raising an alarm when no barcode has been scanned;
when the barcoded has been scanned:
reading data from the barcode;
extracting one or more isolated product images of the product from the one or more captured images;
matching the one or more isolated product images to enrolled images of products in a database;
when a match is found:
retrieving an identifying indicia associated with the enrolled images that matched at least one or the isolated images.
verifying a correct scan of the product when the identifying indicia matches the barcode data;
raising an alarm when the identifying indicia does not match the barcode data.

9. The method of claim 8 further comprising:
extracting a product feature vector from an isolated product image;
wherein matching the isolated product image to the enrolled images comprises:
iterating over all enrolled images or until a match is found, the iteration comprising:
retrieving enrolled feature vectors associated with an enrolled image;
matching the product feature vector to the enrolled feature vector; and
determining whether the product feature vector matches at the enrolled feature vector within the predetermined confidence level.

10. The method of claim 8 further comprising:
extracting a product feature vector from the isolated product image;
wherein matching the one or more isolated images to the enrolled images comprises:
iterating over all enrolled standard images or until a match is found, the iteration comprising:
retrieving, from the gallery, an enrolled feature vector extracted from a next enrolled standard image of a product;
determining a match if a similarity between the product feature vector and the enrolled feature vector from the enrolled standard image match within a pre-determined degree of confidence;
if no match occurs, then:
determining an orientation of the product in the isolated product image;
iterating over all enrolled images having a similar orientation to the isolated product image or until a match is found, the iteration comprising:
retrieving, from the database, one or more enrolled feature vectors extracted from the enrolled images having a similar orientation to the orientation of the product in the isolated product image;
determining a match if a similarity between the product feature vector and one of the one or more enrolled feature vectors from images having a similar orientation as the product match with a pre-determined degree of confidence;
if no match occurs, then:
iterating over all remaining enrolled images or until a match is found, the iteration comprising:
retrieving, from the database, all remaining enrolled feature vectors associated with the enrolled standard image;
determining a match if a similarity between the product feature vector and one of the remaining enrolled feature vectors match with a pre-determined degree of confidence.

11. The method of claim 8 further comprising:
extracting a product feature vector from the isolated product image;
wherein matching the one or more isolated images to the enrolled images comprises:
iterating over all enrolled standard images or until a match is found, the iteration comprising:
retrieving, from the gallery, an enrolled feature vector extracted from an enrolled standard image of a product having a next closest match with the product feature vector;
determining a match if a similarity between the product feature vector and the enrolled feature vector from the enrolled standard image match within a pre-determined degree of confidence;
if no match occurs, then:
determining an orientation of the product in the isolated product image;
retrieving, from the database, one or more enrolled feature vectors extracted from enrolled images having a similar orientation to the orientation of the product in the isolated image and associated with the enrolled standard image;
determining a match if a similarity between the product feature vector and the one or more enrolled feature vectors from images having a similar orientation as the product match with a pre-determined degree of confidence;
if no match occurs, then:
retrieving, from the database, all remaining enrolled feature vectors associated with the enrolled standard image;
determining a match if a similarity between the product feature vector and the remaining enrolled feature vectors match with a pre-determined degree of confidence.

12. The method of claim 8 wherein obtaining isolated images of the product comprises:
detecting the product in the captured images; and
cropping the detected product to obtain the isolated image.

13. The method of claim 12 wherein detecting the product comprises:
inputting the image to a machine learning model trained to detect products in an image and place a bounding box around the product.

14. The method of claim 12 wherein cropping the detected product comprises:
inputting the image to a machine learning model trained to crop products in an image.

15. The method of claim 14 wherein the cropping comprises one of:
extracting the bounding box from the image;
extracting the bounding box from the image and modifying the background within the bounding box; or
segmenting the bounding box to remove the background.

16. A system comprising:
a processor;
one or more cameras coupled to the processor;
a scanning device coupled to the processor;
software that, when executed by the processor, implements the functions of claim 8.
